(19) United States
(12) Patent Application Publication
(10) Pub. No.: US 2006/0186374 A1
(43) Pub. Date: Aug. 24, 2006

(54) Hydrophobic propellant gas mixtures for producing insulating foams

(76) Inventors: Heinrich Sommer, Appenzell (CH); Barbara Poggenklas, Gossau (CH)

Correspondence Address: FULBRIGHT AND JAWORSKI LLP, 555 S. FLOWER STREET, 41ST FLOOR, LOS ANGELES, CA, 90071, US

(21) Appl. No.: 10/543,038

(22) PCT Filed: Dec. 23, 2003
(86) PCT No.: PCT/EP03/14765

§ 371 Date: Dec. 15, 2005

(30) Foreign Application Priority Data
Jan. 23, 2003 (DE) 103 02 734.3

(51) Int. Cl. C08G 18/48; H01M 4/88

(52) U.S. Cl. 252/182.1; 521/131

(57) ABSTRACT

The invention relates to a prepolymer composition particularly for the production of insulating foams to be delivered from pressure packs, with a prepolymer component comprising a prepolymer with silane groups for cross-linking the prepolymer with a second component and containing customary additives, and a propellant gas component which is liquid under the pressure prevailing in the pressure pack and which is at least partially dissolved in the prepolymer component, with the propellant gas component having a log P_{O/W} value of ≧1.90 where P_{O/W} denotes the distribution coefficient of the propellant gas component in octanol/water, as well as the use of a propellant gas mixture having a log P_{O/W} value of ≧1.90 for the production of insulating foams made of prepolymers containing polar reactive groups in pressure packs.

The invention relates to a prepolymer composition for the production of insulating foams to be delivered from pressure packs, with a prepolymer component comprising a prepolymer with silane groups for cross-linking the prepolymer with a second component and containing customary additives, and comprising a propellant gas component which is liquid under the pressure prevailing in the pressure pack and which is at least partially dissolved in the prepolymer component, as well as to the use of certain propellant gas mixtures for the production of insulating foams made of prepolymers containing polar reactive groups.

Insulating foams for the filling of cavities or hollow spaces are frequently produced in the form of formed-in-place foam from pressure packs using polyurethane prepolymer mixtures. Main fields of application are in the building trade but also technical products involving hollow spaces to be filled in order to prevent condensation water from accumulating.

Prepolymers for the production of polyurethane insulating foams contain polyisocyanate groups having cross-linking capabilities that when reacting with a polyol component or water cause the actual polymer to be formed. The foam structure is produced by CO₂ generated through the reaction with water and/or by the propellant gas existing in the prepolymer mixture. For the foaming of prepolymer compositions containing isocyanate groups mainly propellant gas mixtures are used at present that contain butanes, propane, dimethyl ether and, if applicable, also fluorocarbons.

Furthermore, from WO 00/04069 A1 prepolymer mixtures are known that, when attached to a polyurethane skeleton, contain terminal silane groups as reactive groups which are suited to react with water as second component. During this reaction an alkanol, usually methanol, is liberated.

Basically, these silane terminated foams offer the advantage that the prepolymers used do not have toxic isocyanate functions. The methanol liberated with silane terminated foams is regarded as being hardly problematic because, among other things, it arises in relatively small volumes and evaporates rapidly. In this respect, the silane terminated prepolymers have the potential to substitute the customary isocyanate terminated prepolymers.

When foaming silane terminated prepolymers by means of customary propellant gas mixtures foams having a very fine cell structure are obtained provided these foams are applied to a plane or level working surface. However, when filling joints with foam as, for example, is done in practice when filling the joints around door and window casings it is noticed that the foam creeping out of the joint has a good cell structure whereas the foam structure within the joint shows voids and cracks which may at least impair the insulating effect of the foam but to some extent may also negatively affect its mounting properties. In extreme cases it has been found the foam had collapsed almost completely.

Investigations have shown that the problems with foams produced from silane-terminated prepolymers are linked with the liberation of methanol. When escaping from the foam methanol softens the cell structures and thus renders them capable of absorbing the propellant gas. The loss of propellant gas before final hardening has taken place will cause the foam to collapse. Crack-free foam structures having a good cell structure cannot be obtained from silane terminated prepolymers, at least not when using customary propellant gas mixtures as employed for the foaming of prepolymers containing isocyanate groups such as, for example, butane, propane, dimethyl ether, fluorocarbon mixtures.

Consequently, the objective of the underlying invention is to provide a prepolymer composition especially for the production of insulating foams from silane terminated prepolymers that offers improved properties in terms of foam stability and cracking.

Surprisingly, it has been found that good foams are obtained with prepolymer compositions of the nature described hereinbefore when they comprise a propellant gas component of a log P_{O/W} value of ≧1.70, where P_{O/W} represents the distribution coefficient of the propellant gas component in octanol/water. Preferred is a log P_{O/W} value of ≧1.90.

Silane groups in the sense of the invention are preferably terminal silane groups linked with a polyurethane skeleton known per se, and in particular methoxy and ethoxysilane groups. The functionality of the prepolymer is ≧2. Preferred are trimethoxysilane and methyl dimethoxysilane functions.

The polarity and hydrophobia of the propellant gas component appears to have a decisive influence on the stability of the foam. The distribution coefficient P_{O/W} reflects, here as a logarithmic representation, the distribution of a substance in a nonpolar (octanol) and a polar (water) solvent. The higher the log P_{O/W} value, the lower the polarity of the substance measured and the higher its affinity to nonpolar hydrocarbons and its hydrophobia.

According to the invention the decadic logarithm of the P_{O/W} value of a propellant is employed. For the customarily used propellant gas mixtures the average of the log P_{O/W} values of the individual propellants weighted with the propellant gas mixture in grams is calculated and used as limiting criterion. Experience has shown that the weighted average of the logarithmic values is a sufficiently exact approximation.

It has therefore been established that for the silane-group containing prepolymers the nonpolarity of the propellant gas component is associated with the polarity of the prepolymer component und/or agents liberated from the reactive groups, for instance methanol or ethanol from methoxy- or ethoxysilane-terminated prepolymers.

The preparation rules according to the invention apply to both the one-component foams and two-component foams. They also apply to foams that only react partially with a second component released inside a pressurized container or pack and otherwise with the water present in the atmosphere, so-called 1.5 component foams.

It is assumed that, according to the invention, the stabilizing effect of the propellant gas component having nonpolar and hydrophobic properties is due to the propellant gases being better retained in the cells forming after the foam has been expelled because their dissolution behavior in the polar cell membranes which may also be enriched additionally with methanol or ethanol is impeded. On account of the dissolution effect thus being delayed the prepolymer has time for cross-linking, alcohol can evaporate and the foam is given time to harden/set.

The prepolymer components used according to the invention coincide with those known in the state of the art. For example, said components may be isocyanate-terminated but also silane-terminated, as for instance described in WO 00/04069 A1. Such silane-terminated prepolymers are based on a customary polyurethane skeleton of an aromatic or aliphatic polyisocyanate and a polyol the isocyanate groups of which were re-functionalized by conversion with a silane compound reacting with it. Silane groups suited for this purpose are, for example, amino methoxysilanes, particularly N-phenyl amino methyltrimethoxysilane und N-phenyl amino methyldimethoxy methylsilane. Details of such prepolymers are included in and can be taken from WO 00/04069 A1 as well as WO 02/66532 A1, WO 02/68491 A1, WO 02/70586 A1 and WO 02/77072 A1, the recipes or formulations of which are expressly included here.

The minimum log P_{O/W} value to be adhered to which according to the invention is indicated to be ≧1.70 depends to a certain degree on the polarity of the prepolymer or the polarity of the product liberated from the prepolymer as a result of the cross-linking reaction and its quantity. Accordingly, a limit value of log P_{O/W}≧1.90 applies in any case to dimethoxymethylsilane-terminated prepolymers which only release two molecules of methanol per silane unit.

When using trimethoxysilane-terminated prepolymers three molecules of methanol are liberated per silane group, the last of which in a delayed cross-linking reaction following the first two. To make allowance for the greater methanol volume a higher log P_{O/W} value of ≧2.35 or even 2.40 is called for to obtain foam having an acceptable quality. In the event of mixed systems and systems based on ethoxysilanes for example, lower or intermediate values may be applied. In any case, adhering to a log P_{O/W} value of ≧1.70 offers advantages also with other silane-terminated prepolymers, for example, prepolymers having a basic skeleton that differs from a polyurethane one. As mentioned earlier, the propellant gas components intended for use have nonpolar and hydrophobic characteristics. Suitable propellant gases are, in particular, hydrocarbons having up to 5 C-atoms, both saturated and unsaturated, as well as fluorocarbons and, in particular, i-butane, n-butane, propane, R227ea (1,1,1,2,3,3,3-heptafluoropropane), R365mfc (1,1,1,3,3-pentafluorobutane), R245fa (1,1,1,3,3-pentafluoropropane), R134a (1,1,1,2-tetrafluoroethane), R152a (1,1-difluoroethane) and, to a limited extent, DME (dimethyl ether). These propellant gases may be employed by themselves, mixed with each other as deemed expedient, as well as mixed with other compounds offering propellant gas properties. Generally, the propellant gas component should have a boiling point of ≦40C. and, in particular, ≦20° C. depending on field and conditions of application. As a rule, these are liquefiable gases which are contained in the pressure pack such that they are, at least partially but preferably entirely, dissolved in the prepolymer components and/or stably emulsified.

To adjust the solubility and viscosity of the prepolymer composition to values conducive to the pressure pack itself and the discharge from pressure packs it is, in particular, preferable to provide the composition with customary additives that influence its viscosity and solubility properties. The viscosity may, for instance, be adjusted with the aid of customary phosphates, such as triethylphosphate, that also have a flame-retardant effect. Moreover, for viscosity adjusting purposes vinyltrimethoxysilane may be used in the known manner and has a positive influence on the solubility of the propellant gas component in the prepolymer component. Furthermore, vinyltrimethoxysilane also serves as adhesion promoter for the product; however, it causes additional methanol volumes to be released when it reacts with moisture present in air. In this respect, the polarity of the prepolymer component, its content of methanol that can be liberated, its capacity to absorb and capability to dissolve the propellant gas component, and the polarity of the foam that has formed can be influenced and adjusted by the vinyltrimethoxysilane content of the prepolymer composition.

Dimethyl ether may be used for the fine adjustment of the propellant gas component's polarity because of its significantly low log P_{O/W} value. Basically, however, dimethyl ether is not suited when higher log P_{O/W} values are to be achieved.

Generally speaking, the propellant gas component amounts to 20 to 40% v/v of the prepolymer composition according to the invention, in particular to approximately 25 to 35% v/v. In this context preferably at least ⅔ of the propellant gas component consist of non-polar constituents, in particular at least 5/6 of said component. Non-polar constituents for this purpose are those constituents that have a log P_{O/W} value of ≧1.35.

An overview of the log P_{O/W} values of some suitable propellant gases is given below.

| Propellant gas | log P_{O/W} |
|---|---|
| i-butane | 2.8 |
| R227ea | 2.5 |
| Propane | 2.3 |
| R365mfc | 1.6 |
| R245fa | 1.35 |
| R134a | 1.06 |
| R152a | 0.75 |
| DME | 0.1 |

Furthermore, the prepolymer compositions according to the invention comprise of customary accessory substances and additives such as catalysts from production reactions and for the cross-linking reaction, stabilizers, viscosity and rheology regulators, cell regulators, softeners, flame retardants and the like.

The invention is explained in more detail by way of the following examples.

Production of the PU Prepolymer:

The prepolymer is obtained by converting TDI type T80 using a polypropylene glycol MG=400 at a molar ratio NCO:OH=2.0. These prepolymers are produced in a customary manner by having the TDI available in a reactor under a protective gas shield and adding polyol in a temperature-controlled fashion taking care not to exceed 80° C. When the addition of polyol has been completed the temperature of 80° C. is maintained for a period of 3 hours. The NCO content of the prepared prepolymer amounts to 11.2% (theoretically) and is titrimetrically determined by conversion of the prepolymer with dibutylamine in toluene solution and subsequent back titration using an HCl solution. As soon as a constant NCO content is arrived vinyltrimethoxysilane is admixed and the mixture is vigoroulsy stirred for another 5 minutes.

Composition for the formulations:

434 g Desmodur T80 (Bayer AG)

497 g Voranol P400 (DOW)

82 g Vinyltrimethoxysilane

Production of the Silane-Terminated Prepolymer:

The prepolymer obtained in this way together with additives (foam stabilizer, amine catalyst, vinyltrimethoxysilane as dilution agent and adhesion promoter) is directly weighed in and filled into the aerosol can. Following this, the slightly overstoichiometric addition of aminosilane takes place, the can is provided with and closed off using a customary valve and the propellant gas is applied immediately. After the constituents have been added the can is vigorously shaken. Within a period of 30 s the inside temperature rises by 20 to 30° C. The cans are stored overnight at room temperature and are then ready for use. For reaction checking purposes the contents of the can is examined by FT-IR spectroscopy. An isocyanate peak can no longer be detected.
Prepolymer 1: Conversion product of PU prepolymer with N-phenyl amino methyltrimethoxysilane.
Prepolymer 2: Conversion product of PU prepolymer with N-phenyl amino methyldimethoxy methylsilane.
   Formulations

Making use of the above described silane-terminated prepolymers the prepolymer compositions listed in the following table were produced with the propellant gas components indicated and the resultant foam was discharged from a customary pressure pack. The stabilizer used is a foam stabilizer furnished by the company of Goldschmidt AG in Essen, the catalyst ZF-20 bis-(2-dimethyl-amino ethyl)ether is produced by the company of Huntsman.

For evaluation purposes two chipboards of size 14×14×1.9 cm were immersed in water for 20 seconds. Afterwards, the boards were set up vertically for 100 s to enable the water to drain off and avoid remaining water accumulation and moisture. Using spacers (polyethylene rods) a horizontal joint of size 14×9.5×2.5 cm was prepared. A load of 12.5 kg was applied to the joint and the joint was then completely filled with foam. After one day's time crept-out foam was cut off and the quality of the foam present in the joint was assessed. For this purpose the joint was cut through in longitudinal direction. For the assessment value 1 (homogeneously thru-hardened foam joint), value 2 (crack formation in the foam joint) and value 3 (complete collapse found in the joint) were assigned. The results are also listed in the table below.

Formulations

| | Test No. | | | | | | | | | |
|---|---|---|---|---|---|---|---|---|---|---|
| | 1 | 2 | 3 | 4 | 5 | 6 | 7 | 8 | 9 | 10 |
| Prepolymer 1 | 100 | 100 | 100 | 100 | 100 | 100 | 100 | | | |
| Prepolymer 2 | | | | | | | | 100 | 100 | 100 |
| Tegostab B8443 | 2.4 | 2.4 | 2.4 | 2.4 | 2.4 | 2.4 | 2.4 | 2.4 | 2.4 | 2.4 |
| Catalyst ZF-20 | 0.8 | 0.8 | 0.8 | 0.8 | 0.8 | 0.8 | 0.8 | 0.8 | 0.8 | 0.8 |
| Propellant gas | | | | | | | | | | |
| R134a | | | | 3 | | | | 43 | | |
| Propane | 6.5 | 4.5 | | 6 | 6 | 6 | 4.5 | | 6 | 6 |
| i-butane | 13 | 9 | | 12 | 12 | 12 | 9 | | 12 | 12 |
| DME | | | | | | 3 | | | 10 | 5 |
| R152a | | | | | 3 | | | | | |
| R365mfc | | | | | | | | | | |
| R227 | | 12 | 50 | | | | | | | |
| R245 | | | | | | | 12 | | | |
| % v/v | 26% | 25% | 25% | 26% | 26% | 26% | 25% | 26% | 32% | 28% |
| Ø log P_{o/w} | 2.63 | 2.57 | 2.50 | 2.41 | 2.36 | 2.27 | 2.03 | 1.06 | 1.73 | 2.08 |
| Joint assessment | 1 | 1 | 1 | 1 | 2 | 3 | 3 | 3 | 3 | 1 |
| Foam string Ø 2 cm | fine- | fine- | fine- | fine- | fine- | feinzellig | feinzellig | feinzellig | feinzellig | feinzellig |
| | celled | celled | celled | celled | celled | | | | | |

All values in parts by weight, unless otherwise indicated.

1. Prepolymer composition particularly for the production of insulating foams to be delivered from pressure packs, with a prepolymer component comprising a prepolymer with silane groups for cross-linking the prepolymer with a second component and containing customary additives, and a propellant gas component which is liquid under the pressure prevailing in the pressure pack and which is at least partially dissolved in the prepolymer component, characterized in that, the propellant gas component has a log P_{O/W} value of ≧1.70 where P_{O/W} denotes the distribution coefficient of the propellant gas component in octanol/water.

2. Prepolymer composition according to claim 1, characterized in that the prepolymer comprises of methyldimethoxysilane groups.

3. Prepolymer component according to claim 2, characterized in that the log P_{O/W} value of the propellant gas component is ≧1.90.

4. Prepolymer composition according to claim 1, characterized in that the prepolymer comprises of trimethoxysilane groups.

5. Prepolymer component according to claim 4, characterized in that the log P_{O/W} value of the propellant gas component is ≧2.35.

6. Prepolymer composition according to at least one of the above claims, characterized in that the propellant gas component has a boiling point of ≦40 C.

7. Prepolymer composition according to at least one of the above claims, characterized in that the propellant gas component has a boiling point of ≦20 C.

8. Prepolymer composition according to at least one of the above claims, characterized in that the propellant gas component contains i-butane, n-butane, propane, R227ea, R365mffc, R245fa, R134a, R152a, dimethyl ether or blends of these constituents with each other or with other propellant gases.

9. Prepolymer composition according to at least one of the above claims, characterized in that the propellant gas component represents 20 through 40% v/v of the prepolymer composition.

10. Prepolymer composition according to at least one of the above claims, characterized in that at least ⅔ of the propellant gas component consist of non-polar propellants.

11. Prepolymer composition according to at least one of the above claims, characterized in that at least ⅚ of the propellant gas component consist of non-polar propellants.

12. Use of a propellant gas mixture having a log P_{O/W} value of ≧1.70 for the production of insulating foams from prepolymers containing silane groups in pressure packs.

13. Use according to claim 12, characterized in that the prepolymer is a silane-terminated prepolymer.

14. Use according to claim 13, characterized in that the prepolymer comprises of trimethoxysilane groups.

15. Use according to claim 14, characterized in that the propellant gas component has a log P_{O/W} value of ≧2.35.

16. Use according to at least one of the above claims 12 thru 15, characterized in that the propellant gas component contains i-butane, n-butane, propane, R227ea, R365mffc, R245fa, R134a, R152a, dimethyl ether or blends of these constituents with each other or with other propellant gases.
